(19) United States
(12) Patent Application Publication
(10) Pub. No.: US 2025/0307251 A1
(43) Pub. Date: Oct. 2, 2025

(54) INSIGHT GENERATION TO FACILITATE INTERPRETATION OF INFERENCE MODEL OUTPUTS BY END USERS

(71) Applicant: Dell Products L.P., Round Rock, TX (US)

(72) Inventors: LEV MAKLER, Be'er Sheva (IL); OFIR EZRIELEV, Be'er Sheva (IL); ANAT PARUSH TZUR, Tel Aviv (IL); AMIHAI SAVIR, Newton, MA (US)

(21) Appl. No.: 18/622,034

(22) Filed: Mar. 29, 2024

(51) Int. Cl. G06F 16/2457

(52) U.S. Cl. CPC G06F 16/24575; G06F 16/9035; G06N 3/042

(57) ABSTRACT

Methods and systems for facilitating interpretation of outputs from inference models by end users are disclosed. To do so, questions usable to establish a level of confidence in the outputs may be obtained using a first large language model (LLM) and a second LLM. The questions and contextual data may be ingested by a third LLM to generate insights to provide a response to the questions. A fourth LLM may emulate a persona of an end user to determine an extent to which the insights are relevant to the end user. A success score may be assigned to the insights. If the success score meets success criteria, the insights may be considered acceptable and may be provided to the end user for use in providing computer-implemented services. If the insights are not considered acceptable, the questions may be iteratively modified until insights based on the modified questions are considered acceptable.

### FIELD

Embodiments disclosed herein relate generally to interpreting inference model outputs. More particularly, embodiments disclosed herein relate to systems and methods to facilitate interpretation of inference model outputs by end users using responses to questions generated based on at least the inference model outputs.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a block diagram illustrating a system in accordance with an embodiment.

FIGS. 2A-2B show data flow diagrams illustrating generation of questions usable to interpret an inference model output in accordance with an embodiment.

FIG. 2C shows a data flow diagram illustrating generation of insights based on questions in accordance with an embodiment.

FIGS. 2D-2E show data flow diagrams illustrating evaluation of relevance of insights to end users in accordance with an embodiment.

FIG. 3 shows a flow diagram illustrating a method of generating insights usable to interpret an inference model output by an end user in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for interpreting inference model outputs. An inference model may generate outputs (e.g., inferences, predictions) by ingesting input data from any number of data sources and may provide the outputs to any number of downstream consumers (e.g., end users). The downstream consumers may provide computer-implemented services and/or make decisions based on the outputs.

Prior to making the decisions and/or providing the computer-implemented services, the downstream consumers may establish a level of confidence in each output of the outputs. The level of confidence may determine, at least in part, whether the downstream consumer utilizes the outputs as a basis for making decisions and/or providing the computer-implemented services.

To establish the level of confidence, input data ingested by the inference model to generate the output (and/or data sources that provided the input data) may be evaluated. Evaluating the input data may include identifying portions of the input data (e.g., particular data sources from which the input data was obtained, particular types of the input data) that most significantly contributed (e.g., based on a threshold and/or other criteria) to generation of the outputs by the inference model. Those portions of the input data may be further examined and/or analyzed to establish a quality of the data and/or data source, a reliability of the data and/or data source, a relevance of the data and/or data source, etc.

However, evaluating the input data may require a subject matter expert (SME) and/or other individual to manually examine and/or analyze the input data (e.g., via manual input of information using a device). Manual examination of the input data may be a time-intensive process, may place an undesirable cognitive burden on the downstream consumer (e.g., the SME and/or the other individual), and/or may consume an undesirable quantity of resources of the downstream consumer that may otherwise be allocated by providing the computer-implemented services to consumers of the computer-implemented services.

In addition, manual and/or partially manual evaluation of the input data performed by the SME may be vulnerable to human error which may lead to, for example, an output of the outputs being assigned a higher level of confidence or a lower level of confidence than warranted based on any criteria for assigning levels of confidence. Assigning inappropriate levels of confidence to the outputs may lead to decisions being made based on less reliable predictions which may, therefore, negatively impact an availability and/or quality of the computer-implemented services.

To quantitatively evaluate the input data (e.g., with reduced intervention by the SME and/other user), a first large language model (LLM) may attempt to answer a set of queries related to the outputs by ingesting: (i) the outputs, (ii) the input data, (iii) the set of queries, and/or (iv) other data usable to evaluate the input data.

For example, the output may include a first prediction. A first query of the set of queries may prompt the first LLM to identify leading indicators for the first prediction. The first LLM may ingest at least the first prediction and the input data that was used to generate the prediction to identify portions of the ingest data that were most impactful in generating the first prediction (e.g., the leading indicators). Additional queries of the set of queries may prompt the first LLM to identify other portions of the input data such as emerging trends corresponding to the leading indicators.

Following answering each query of the set of queries, a second LLM may ingest at least the responses generated by the first LLM (e.g., leading indicators and emerging trends for the output) to generate one or more questions. The one or more questions may be usable to establish the level of confidence in the output.

To do so, a third LLM may ingest: (i) the one or more questions, (ii) contextual data, and/or (iii) other data to generate insights intended to provide responses to the one or more questions. The contextual data may include, for example, economic report data and/or other types of information. Therefore, the insights generated by the third LLM may include responses to the one or more questions in the context of, for example, recent economic data, recent financial filings of a company, etc.

However, a downstream consumer (e.g., an end user) may be unable use the insights if the insights are not relevant to the end user. To determine whether the insights are relevant to the end user, the insights may be evaluated in context of needs of the end user. To evaluate the insights, a fourth LLM may ingest end user information to emulate a persona of the end user. The fourth LLM may then evaluate an extent to which the insights are relevant to the end user while emulating the persona.

A success score may be generated based on the extent to which the insights are relevant to the end user and the success score may be compared to success criteria. If the success score meets the success criteria, the insights may be determined to be acceptable and may be provided to the end user for use in interpreting the output from the inference model.

If the success score does not meet the success criteria, the question on which the insights were based may be iteratively modified until insights based on the modified question are determined to be acceptable.

Thus, embodiments disclosed herein may provide an improved system for facilitating interpretation of outputs from inference models by end users. By utilizing the fourth LLM to emulate the persona of the end user, a likelihood that the insights will be relevant to the end user may be increased. By doing so, the end user may more efficiently determine whether predictions (e.g., from the outputs) are to be used as a basis for providing computer-implemented services which may, therefore, increase a quality and a reliability of the computer-implemented services.

In an embodiment, a method for interpreting an output generated by an inference model is provided. The method may include: obtaining a question, the question being usable to establish a level of confidence in the output and the question being generated by a second large language model (LLM); obtaining, using at least the question and contextual data, insights intended to provide a response to the question, the insights being generated by a third LLM; obtaining, based on end user information and the insights, a success score for the insights, the success score being generated by a fourth LLM and the success score indicating an extent to which the insights are useful to an end user associated with the end user information; making a first determination, based on the success score and success criteria, regarding whether the insights are acceptable; and in a first instance of the first determination in which the insights are acceptable: providing the insights to the end user for use in interpreting the output.

The method may also include: in a second instance of the first determination in which the insights are not acceptable: obtaining updated insights; making a second determination regarding whether the updated insights are acceptable; and in a first instance of the second determination in which the updated insights are not acceptable: continuing to iteratively modify the updated insights until the modified updated insights are acceptable.

Obtaining the updated insights may include: modifying the question to obtain an updated question; and using the updated question as input for the third LLM to generate the updated insights.

The end user information may include at least one selected from a list consisting of: text generated by the end user; an educational history of the end user; an employment history of the end user; and historic behavior of the end user.

Obtaining the success score may include: ingesting, by the fourth LLM, the end user information to emulate a persona of the end user, the persona being usable to predict behavior of the end user; and evaluating, by the fourth LLM while emulating the persona, an extent to which the response to the question provided by the insights is relevant to the end user.

The end user may be an individual.

The end user may be a role within a business and the business having at least two individuals that perform the role.

The insights may be acceptable when the success score meets the success criteria.

Obtaining the question may include: obtaining, based on at least the output, analytic data generated by a first large language model (LLM), the analytic data comprising: leading indicators from ingest data used by the inference model to generate the output; and emerging trends from the ingest data used by the inference model to identify the leading indicators; and obtaining, using at least the analytic data and a set of question generation templates, the question generated by a second LLM.

Obtaining the analytic data may include: feeding first ingest data into the first LLM, the first ingest data comprising: inference model ingest data used by the inference model to generate the output; the output; and a set of queries comprising questions to be answered by the first LLM, the questions being based on the inference model ingest data and the output; and obtaining, as output from the first LLM, the analytic data.

The contextual data may include economic report data.

The method may also include: in the first instance of the first determination in which the insights are acceptable: applying reinforced learning to the second LLM using at least the question to increase a likelihood of questions generated by the second LLM at future points in time being usable to obtain insights that meet the success criteria.

The output may include a prediction for a condition impacting a business at a future point in time.

The condition impacting the business at the future point in time may be a change in availability of supply of a product from a supplier.

The question may be usable to identify facts to establish a causal relationship between at least a portion of the output and at least a portion of the analytic data.

In an embodiment, a non-transitory media is provided. The non-transitory media may include instructions that when executed by a processor cause the computer-implemented method to be performed.

In an embodiment, a data processing system is provided. The data processing system may include the non-transitory media and a processor, and may perform the method when the computer instructions are executed by the processor.

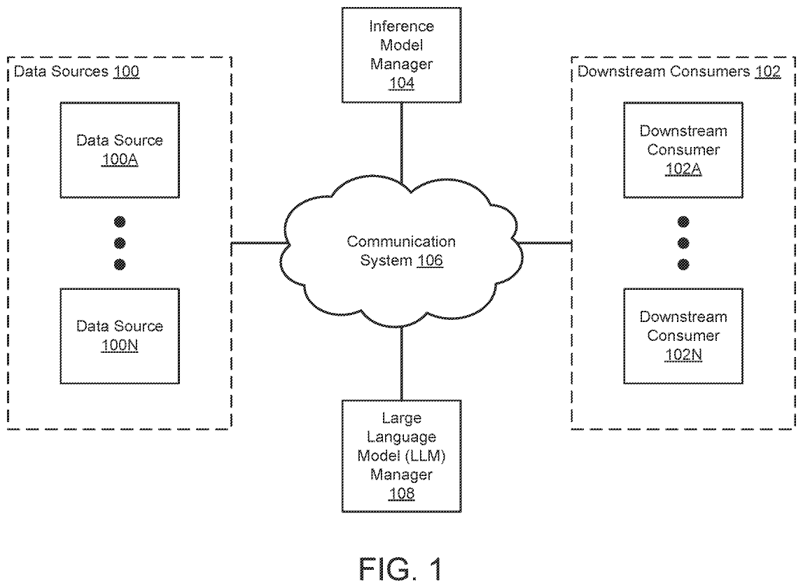

Turning to FIG. 1, a block diagram illustrating a system in accordance with an embodiment is shown. The system shown in FIG. 1 may provide computer-implemented services that may utilize inference models as part of the provided computer-implemented services.

The inference models may be artificial intelligence (AI) models and may include, for example, linear regression models, deep neural network models, and/or other types of inference generation models. The inference models may be used for various purposes. For example, the inference models may be trained to make predictions, recognize patterns, automate tasks, and/or make decisions.

The computer-implemented services may include any type and quantity of computer-implemented services. The computer-implemented services may be provided by, for example, data sources 100, inference model manager 104, downstream consumers 102, LLM manager 108, and/or any other type of devices (not shown in FIG. 1). Any of the computer-implemented services may be performed, at least in part, using inference models and/or inferences obtained with the inference models.

Data sources 100 may include any number of data sources (100A-100N) that may obtain (i) training data usable to train inference models, and/or (ii) ingest data that is ingestible into trained inference models to obtain corresponding inferences. The inferences generated by the inference models may be provided to downstream consumers 102 for downstream use.

Downstream consumers 102 may include any number of data processing systems (e.g., devices) that an end user may utilize to provide, all or a portion, of the computer-implemented services. When doing so, downstream consumers 102 may consume inferences obtained by inference model manager 104 (and/or other entities using inference models managed by inference model manager 104).

However, if inferences from inference models are unreliable (e.g., irrelevant to an end user, of poor quality, based on unreliable data), downstream consumers 102 may be unable to provide, at least in part, the computer-implemented services, may provide less desirable computer-implemented services, and/or may otherwise be impacted in an undesirable manner.

To increase a likelihood of reliably providing the computer-implemented services, downstream consumers 102 may establish a level of confidence in an output (e.g., an inference, a prediction) from an inference model. To do so, a subject matter expert (SME) and/or other end user (e.g., of one or more of downstream consumers 102) may analyze inference model ingest data (e.g., data from data sources 100 used by the inference model to generate the output) to identify one or more leading indicators and/or one or more emerging trends in the inference model ingest data.

A leading indicator may be data source, a type of data, and/or any other element of the inference model ingest data that significantly contributed (e.g., contributed to an extent considered significant based on any criteria and/or based on any threshold for levels of contribution) to generation of the output by the inference model. An emerging trend may include a portion of the inference model ingest data corresponding to the leading indicator.

For example, a leading indicator may be a first type of data obtained from a first data source. The first type of the data may be revenue of a supplier of a product at a future point in time. The emerging trend may include, for example, a portion of the ingest data indicating a change in the revenue of the supplier at the future point in time.

However, analyzing the inference model ingest data to identify the leading indicators and the emerging trends may be performed manually (e.g., fully manually, partially manually) by the end users (e.g., users of downstream consumers 102) and, therefore, may be vulnerable to human error. In addition, analyzing the ingest data may consume an undesirable quantity of resources (e.g., time resources, computing resources, cognitive resources) that may otherwise be allocated to providing the computer-implemented services.

For example, prior to making decisions and/or providing the computer-implemented services based on the outputs, an end user may manually input information into downstream consumer 102A to establish a level of confidence in the outputs. The process of establishing the levels of confidence may be vulnerable to human error and/or delays may occur during establishment of the levels of confidence that may negatively impact an availability and/or a quality of the computer-implemented services.

In general, embodiments disclosed herein may provide methods, systems, and/or devices for facilitating interpretation of inference model outputs by end users so that levels of confidence in the outputs may be more efficiently and quantitatively obtained. To do so, the system may automate aggregation of information relevant to the end user, the information being usable by the end user during interpretation of the outputs. Consequently, the system may be more likely to provide desired computer-implemented services due to an increased likelihood of efficiently identifying outputs (e.g., predictions) that meet confidence level expectations.

To facilitate interpretation of inference model outputs by end users, a first LLM may generate analytic data, the analytic data including (for each output generated by the inference model): (i) leading indicators from ingest data used by the inference model to generate the output, and/or (ii) emerging trends from the ingest data used by the inference model to identify the leading indicators.

The analytic data, the set of question generation templates, and/or other data may be fed into the second LLM to generate one or more questions. A first question generation template of the set of question generation templates may, for example, prompt the second LLM to generate a question usable to identify facts to establish a causal relationship between a portion of the output and a portion of the analytic data. The questions may prompt a third LLM to generate insights that may include responses to the questions.

To obtain the insights, the third LLM may ingest: (i) a question, (ii) contextual data, and/or (iii) other data and may generate the insights as an output. The contextual data may include economic report data, financial data, news articles, and/or other information usable to contextualize a response to the question.

Prior to providing the insights to the end user for use in interpreting the outputs from the inference model, the insights may be evaluated to determine whether the insights are useful to the end user. To do so, a success score may be generated that indicates an extent to which the insights are useful to an end. To obtain the success score, end user information associated with the end user may be fed into a fourth LLM to generate a persona for the end user. The fourth LLM may evaluate the insights while emulating the persona to determine an extent to which the insights are relevant to the end user.

If the success score meets success criteria, the insights may be considered acceptable. If the insights are acceptable, the system of FIG. 1 may provide the insights to the end user for use in interpreting the output. If the insights are not acceptable, the system of FIG. 1 may: (i) obtain updated insights, (ii) determine whether the updated insights are acceptable, and/or (iii) if the updated insights are not acceptable, continue to iteratively modify the updated insights until the modified updated insights are acceptable.

By doing so, generation of insights usable to interpret inference model outputs may be automated and performed quantitatively rather than by a SME or other individual. In addition, by evaluating an extent to which the insights are relevant to a particular end user, insights may be more likely to be relevant (e.g., useful) to the end user. By providing relevant insights to end users, the end users may more efficiently and reliably provide computer-implemented services based on the inference model outputs.

To perform the above-mentioned functionality, the system of FIG. 1 may include data sources 100, inference model manager 104, downstream consumers 102, LLM manager 108, and/or other entities. Data sources 100, downstream consumers 102, inference model manager 104, LLM manager 108, and/or any other type of devices not shown in FIG. 1 may perform all, or a portion of the computer-implemented services independently and/or cooperatively.

Data sources 100 may include any number and/or type of data sources. Data sources 100 may include, for example, data collectors, data aggregators, data repositories, and/or any other entity responsible for providing input data to inference models, LLMs, etc. For example, data sources 100 may provide end user information usable by the fourth LLM to emulate the persona for the end user.

Inference model manager 104 may include any number of devices (e.g., data processing systems) and may be responsible for managing any number of inference models. Inference model manager 104 may: (i) oversee inference model training processes to obtain trained inference models, (ii) host and operate the inference models, (ii) obtain outputs from the inference models, and/or (iii) provide the outputs to another entity responsible for establishing levels of confidence in the outputs.

LLM manager 108 may include any number of devices (e.g., data processing systems) and may be responsible for managing any number of LLMs. LLM manager 108 may: (i) host and operate the LLMs, (ii) obtain outputs from the LLMs, and/or (iii) provide the outputs to another entity responsible for interpreting the outputs from the LLMs.

Downstream consumers 102 (e.g., end users) may include any number of data processing systems operated by end users and may provide all or a portion of the computer-implemented services. When doing so, downstream consumers 102 may obtain outputs obtained by inference model manager 104 (and/or other entities using inference models managed by inference model manager 104). Downstream consumers 102 may be responsible for establishing levels of confidence in the outputs, and/or may determine whether the levels of confidence are sufficient (e.g., via comparison to a threshold) to perform computer-implemented services based on the outputs.

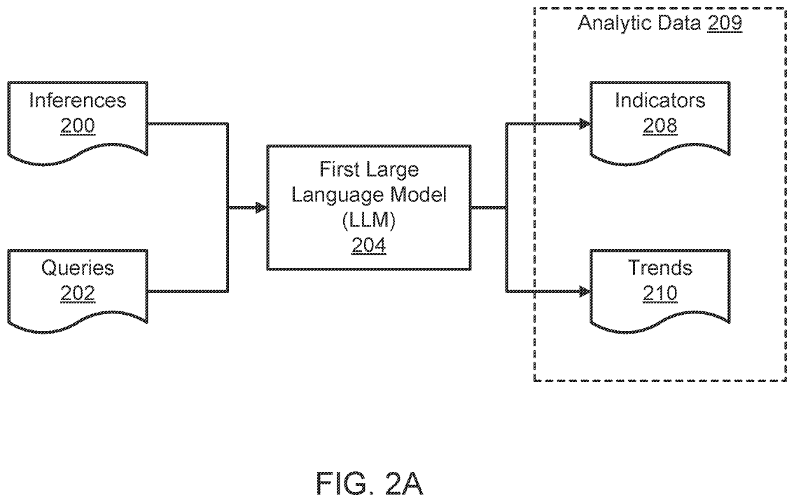

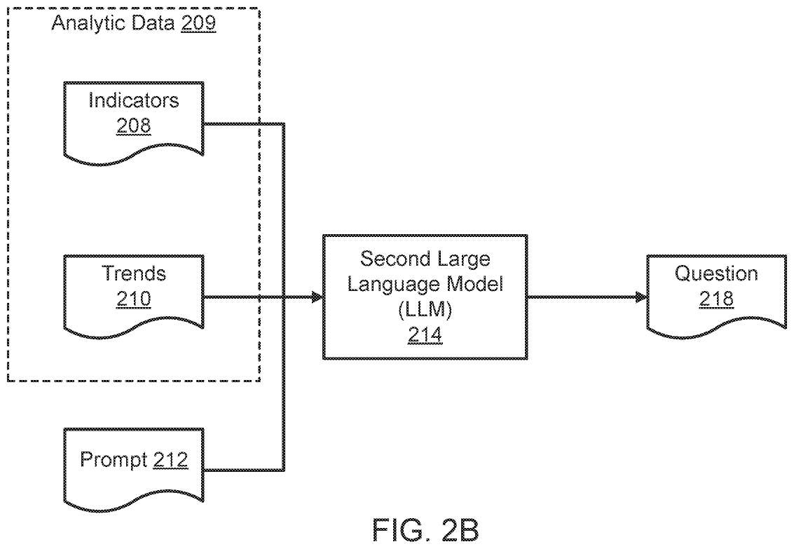

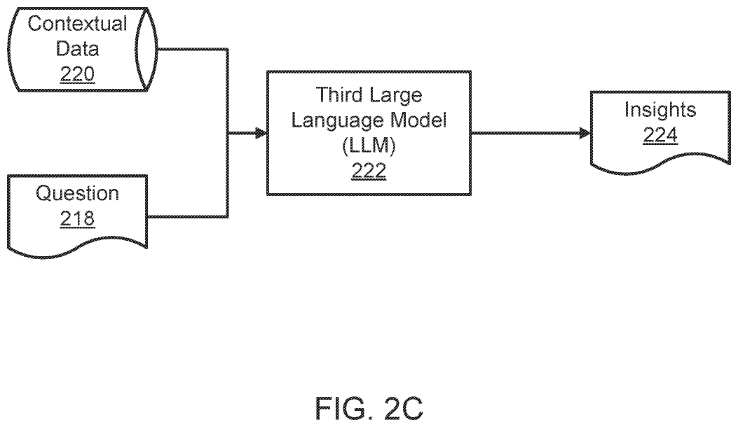

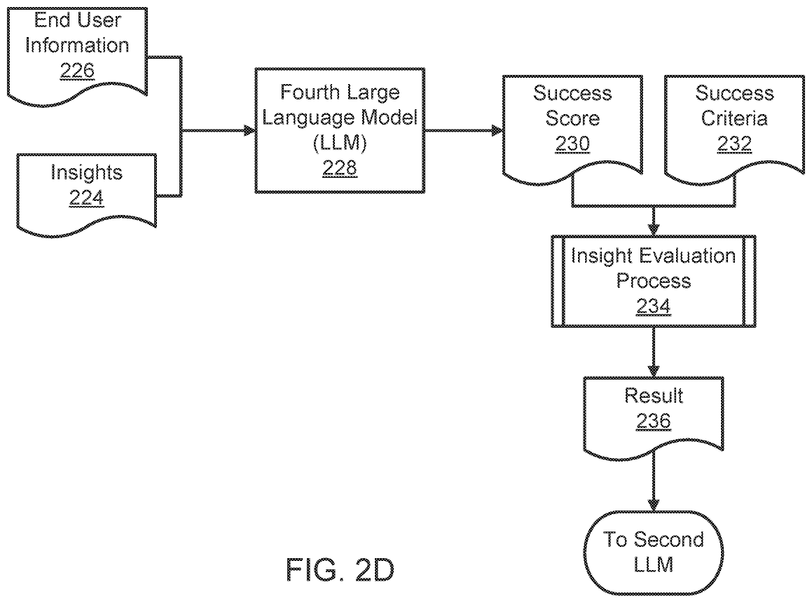

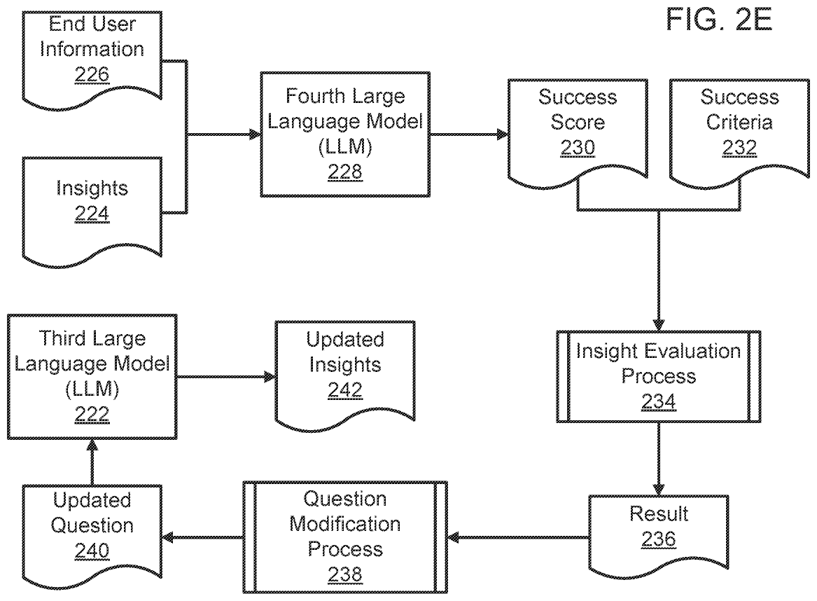

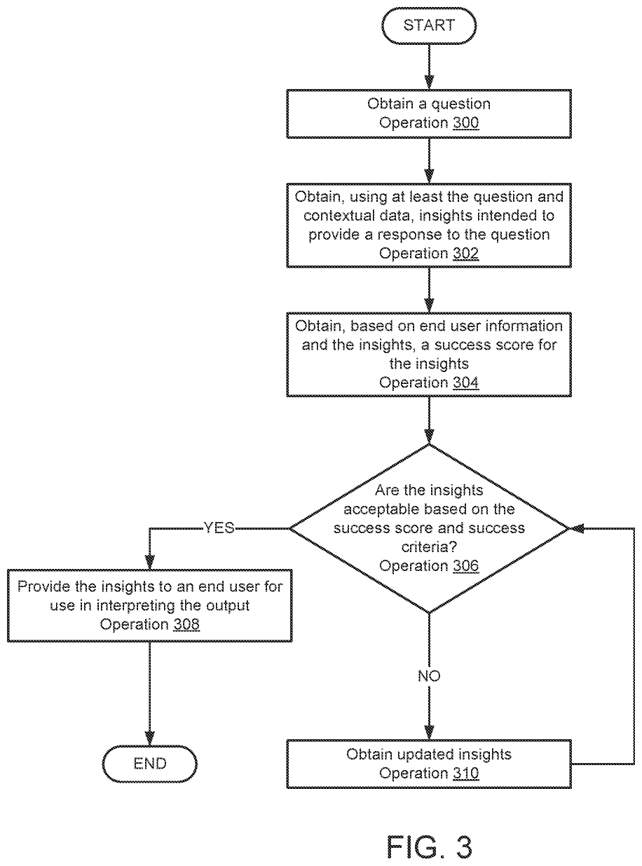

When performing its functionality, one or more of inference model manager 104, data sources 100, LLM manager 108, and downstream consumers 102 may perform all, or a portion, of the methods and/or actions shown in FIGS. 2A-3.

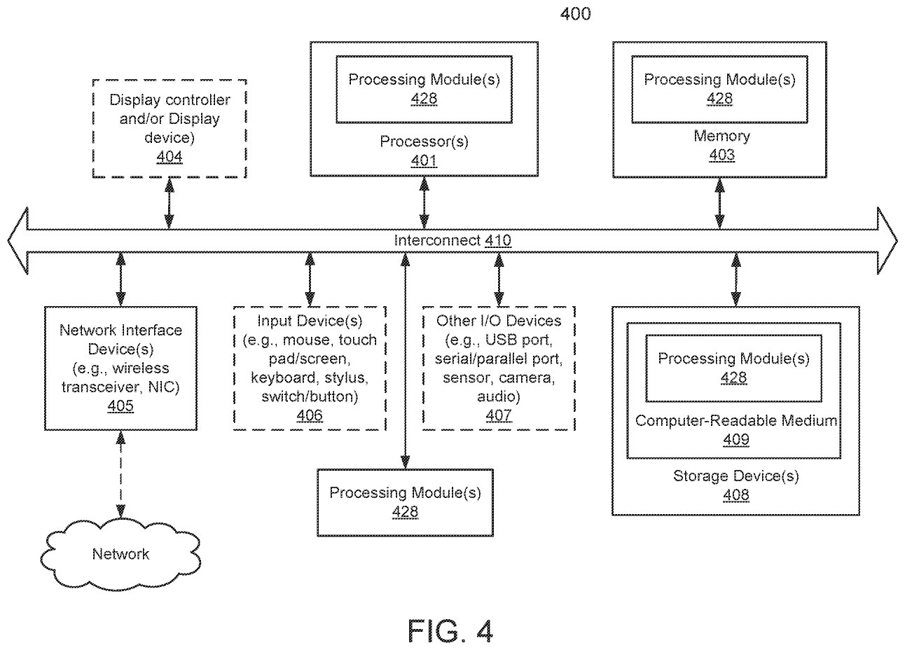

Any of inference model manager 104, data sources 100, LLM manager 108, and downstream consumers 102 may be implemented using a computing device (e.g., a data processing system) such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system. For additional details regarding computing devices, refer to FIG. 4.

Any of the components illustrated in FIG. 1 may be operably connected to each other (and/or components not illustrated) with communication system 106.

Communication system 106 may include one or more networks that facilitate communication between any number of components. The networks may include wired networks and/or wireless networks (e.g., and/or the Internet). The networks may operate in accordance with any number and types of communication protocols (e.g., such as the internet protocol).

Communication system 106 may be implemented with one or more local communications links (e.g., a bus interconnecting a processor of LLM manager 108 and any of the data sources 100, downstream consumers 102, and inference model manager 104).

While illustrated in FIG. 1 as included a limited number of specific components, a system in accordance with an embodiment may include fewer, additional, and/or different components than those illustrated therein.

The system described in FIG. 1 may be used to facilitate interpretation of outputs from inference models by end users in order to improve availability and/or quality of computer-implemented services provided to consumers of the computer-implemented services. The following processes described in FIGS. 2A-2E may be performed by the system in FIG. 1 when providing this functionality.

To further clarify embodiments disclosed herein, data flow diagrams in accordance with an embodiment are shown in FIGS. 2A-2E. In these diagrams, flows of data and processing of data are illustrated using different sets of shapes. A first set of shapes (e.g., 200, 202, etc.) is used to represent data structures, a second set of shapes (e.g., 234, 238, etc.) is used to represent processes performed using and/or that generate data, and a third set of shapes (e.g., 204, 214) is used to represent LLMs.

Turning to FIG. 2A, a first data flow diagram in accordance with an embodiment is shown. In FIG. 2A, a first LLM may generate analytic data usable to interpret outputs from an inference model. Consider a scenario in which an inference model is trained to generate outputs (e.g., inferences 200) to predict a condition impacting a business at a future point in time. The condition impacting the business at the future point in time may include, for example, a change in availability of supply of a product from a supplier.

Specifically, the business may purchase hardware components (e.g., hard drives, computer monitors) from the supplier and the change in the availability of the product may include a decrease in availability of hard drives for purchase by the business at the future point in time.

Inferences 200 may include any number of predictions (e.g., outputs) from the inference model, any amount of inference model ingest data used by the inference model to generate the outputs, and/or other data related to inference generation by the inference model.

Inferences 200, queries 202, and/or the other data may make up first ingest data for first LLM 204. The first ingest data may be fed into first LLM 204 to obtain analytic data 209 as output from first LLM 204.

Queries 202 may include questions to be answered by first LLM 204. The questions may be based on the inference model ingest data and the output. Each query (e.g., question) of queries 202 may be keyed to a portion of inferences 200 (e.g., the output from the inference model). Specifically, a first query may include a question intended to identify leading indicators for a first prediction included in the output a second query may include a question intended to identify emerging trends corresponding to the leading indicators. Additional queries may be included in queries 202 and may be keyed to other predictions included in the output.

For example, the first prediction may indicate, as previously mentioned, that an availability of hard drives for purchase by the business may decrease at the future point in time. A second prediction may indicate that a supply of computer monitors may increase at the future point in time. Therefore, the first query may be intended to identify leading indicators of the predicted decrease in hard drive availability. A third query may be intended to identify leading indicators of the predicted increase in computer monitor availability, etc.

First LLM 204 may be a language model (e.g., an artificial neural network) trained to generate language, understand language, and/or otherwise process requests related to languages. First LLM 204 may be trained using large training datasets to learn statistical relationships within text. First LLM 204 may be trained, for example, to analyze data included in inferences 200 to answer questions included in queries 202.

As previously mentioned, analytic data 209 may be obtained as an output from first LLM 204. Analytic data 209 may include indicators 208 and trends 210. Indicators 208 may include any number of leading indicators and each leading indicator of the leading indicators may be associated with a portion of inferences 200. For example, a first leading indicator may be generated in response to the first query and may identify a type of data and/or a particular data source that contributed most significantly (e.g., compared to a contribution made by other types of data and/or other data sources) to generation of the first prediction of inferences 200.

The first leading indicator may be revenue of the supplier (e.g., the hard drive supplier) at the future point in time. In other words, historical revenue trends for the supplier as well as forecasted future revenue for the supplier may have had a most significant impact on generation of the prediction that the supplier will experience a decrease in availability of hard drives at the future point in time.

Trends 210 may include any number of emerging trends from the ingest data used by the inference model to identify indicators 208. Each emerging trend of trends 210 may be associated with a portion of inferences 200. For example, a first emerging trend of trends 210 may represent a trend in data associated with the first leading indicator. Specifically, the first emerging trend may include data indicating a change in the revenue of the supplier of the hard drives at the future point in time. The first emerging trend may include data (e.g., historical and/or forecasted data) showing a decrease in revenue of the supplier over time.

By generating analytic data 209 automatically using first LLM 204, information indicating how the inference model generated predictions of inferences 200 may be more efficiently identified when compared to manual examination of inference model ingest data by a user.

Turning to FIG. 2B, a second data flow diagram in accordance with an embodiment is shown. To understand an impact of analytic data 209 on inference generation by the inference model, analytic data 209 and prompt 212 may be fed into second LLM 214 to obtain question 218 as output from second LLM 214.

Prompt 212 may include a set of question generation templates. A first question generation template of the set of question generation templates may prompt second LLM 214 to generate a question usable to identify facts to establish a causal relationship between at least a portion of inferences 200 (e.g., the first prediction that the supply of hard drives will decrease at the future point in time) and at least a first portion of analytic data 209 (e.g., indicators 208 and trends 210).

For example, the first question generation template may be keyed to indicator 208 and trend 210. The first question generation template may include information usable to generate a question intended to determine why a decrease in the revenue of the supplier at the future point in time (e.g., as indicated by indicator 208 and trend 210) may cause the supplier to experience a decrease in availability of hard drives (e.g., as indicated by a portion of inferences 200) at the future point in time.

Second LLM 214 may be a language model (e.g., an artificial neural network) trained to generate language, understand language, and/or otherwise process requests related to languages. Second LLM 214 may be trained using large training datasets to learn statistical relationships within text. Second LLM 214 may be trained, for example, to analyze data included in analytic data 209 to generate question 218 based on prompt 212.

Question 218 may include one or more questions usable to interpret the output included in inferences 200. The one or more questions included in question 218 may be usable to search data sources (e.g., economic reports) from which the inference model ingest data was obtained to identify additional data usable to establish a level of confidence in the output.

The level of confidence in the output may be a quantification of a likelihood that the output is reliable and, therefore, useful for providing computer-implemented services. The level of confidence may be established based on any criteria and establishing the level of confidence may include determining, for example, whether a data source from which a leading indicator was obtained is a reliable data source.

A first question of question 218, as previously mentioned, may be intended to determine why a decrease in the revenue of the supplier at the future point in time (e.g., as indicated by indicator 208 and trend 210) may cause the supplier to experience a decrease in availability of hard drives (e.g., as indicated by a portion of inferences 200) at the future point in time.

Turning to FIG. 2C, a third data flow diagram in accordance with an embodiment is shown. In FIG. 2C, a third LLM may generate a response to at least question 218 shown in FIG. 2B. To quantitatively generate the response to question 218, question 218 and contextual data 220 may be ingested by third LLM 222.

Contextual data 220 may include any amount of economic report data and/or other data obtained from: (i) news articles, (ii) economic reports, (iii) financial filings, and/or (iv) other data sources. Contextual data 220 may also include information such as gross domestic product (GDP) over time, financial statements from the supplier over time, etc.

Third LLM 222 may be a language model (e.g., an artificial neural network) trained to generate language, understand language, and/or otherwise process requests related to languages. Third LLM 222 may be trained using large training datasets to learn statistical relationships within text. Third LLM 222 may be trained, for example, to analyze data included in question 218 to generate insights 224 based on contextual data 220.

Insights 224 may be intended to provide a response to question 218. Insights 224 may include any amount of human readable text indicating one or more potential causal relationships between leading indicators and predictions included in inferences 200. Insights 224 may include any number of insights. For example, insights 224 may include a list of potential responses to question 218 ordered (and/or labeled) based on a likelihood that the potential responses are reliable.

Continuing with the above example, question 218 may be intended to determine a causal relationship between a decrease in the revenue of the supplier at the future point in time (e.g., as indicated by indicator 208 and trend 210) and a decrease in availability of hard drives from a supplier (e.g., as indicated by a portion of inferences 200) at the future point in time.

Insights 224 may, therefore, indicate that the decrease in revenue disproportionally impacts the supplier's ability to build hard drives due to a decrease in availability of materials, etc.

Insights 224 may be provided to a downstream consumer for use in establishing a level of confidence in inferences 200. However, if insights 224 are not relevant to the end user, insights 224 may negatively impact the end user's ability to efficiently interpret inferences 200.

Turning to FIG. 2D, a fourth data flow diagram in accordance with an embodiment is shown. The fourth data flow diagram may illustrate data used in and data processes performed in evaluating relevance of insights to an end user.

For an end user to make decisions based on insights 224, insights 224 may need to be relevant to the end user. For example, consider a scenario in which a first end user is an engineer on a research and development team and a second end user is a data analyst. The first end user and the second end user may be employed by the same company but may perform different roles within that company and, therefore, may have different background knowledge and/or skill sets. To perform their respective roles, the first end user and the second end user may find different types of information useful (e.g., applicable based on their background knowledge and/or an intended use of the information).

Insights 224 may be intended to be provided to the first end user (e.g., the engineer). To increase a likelihood that insights 224 are useful to the first end user, an extent to which insights 224 are relevant to the first end user may be evaluated by fourth LLM 228.

To do so, fourth LLM 228 may ingest insights 224 and end user information 226 and may generate, as output from fourth LLM 228, success score 230. End user information 226 may be obtained based on a particular end user for which insights 224 are intended to be used (e.g., the first end user).

While described above with respect to the first end user, it may be appreciated that insights 224 may be intended to be provided to any other end user without departing from embodiments disclosed herein. The end associated with end user information 226 may be a particular individual and/or may be a role within a business. Specifically, a business may have more than one employee performing the role (e.g., more than one engineer) and insights 224 may be intended to be relevant to any of the engineers employed by the business.

End user information 226 may include: (i) text generated by the end user, (ii) an educational history of the end user, (iii) an employment history of the end user, (iv) historic behavior of the end user, and/or (v) other non-private information related to the end user.

Text generated by the end user may include: (i) emails written by the end user, (ii) blog posts written by the end user, (iii) publications written by the end user, and/or (iv) other sources of writing samples.

The educational history of the end user may include: (i) educational institutions attended by the end user, (ii) extra-curricular activities participated in by the end user, (iii) organizations that the end user belonged to while attending the educational institutions, and/or (iv) other educational information.

The employment history of the end user may include: (i) positions held by the end user, (ii) businesses that employed the end user, (iii) professional development performed by the end user (e.g., training sessions attended), (iv) lectures given by the end user, and/or (v) other professional information.

The historic behavior of the end user may include: (i) documents downloaded by the end user, (ii) websites visited by the end user, (iii) videos watched by the end user, and/or (iv) other public online activity of the end user.

Fourth LLM 228 may be a language model (e.g., an artificial neural network) trained to generate language, understand language, and/or otherwise process requests related to languages. Fourth LLM 228 may be trained using large training datasets to learn statistical relationships within text. Fourth LLM 228 may be trained, for example, to emulate personas of end users and/or evaluate relevance of information to the emulated personas.

Fourth LLM 228 may emulate, based on end user information 226, a persona of the end user associated with end user information 226. By emulating the persona, fourth LLM 228 may predict behavior of the end user when encountering information and/or may determine relevance of the information to the end user.

Fourth LLM 228 may ingest insights 224 while emulating the persona and may evaluate an extent to which insights 224 are relevant (e.g., useful) to the end user. As an output, fourth LLM 228 may generate human readable text, the human readable text including terminology indicating whether insights 224 are relevant to the end user. For example, the human readable text may include terminology such as “extremely useful” thus indicating that insights 224 are extremely useful to the end user.

The terminology included in the human readable text may be used to generate success score 230. To do so, the human readable text may be compared to a rule set for quantifying relevance of insights 224 based on human readable text. The rule set may include a set of bands that each correspond to a success score (e.g., a quantitative score) representing a degree of relevance to the end user. For example, the human readable text may be assigned to a first band if the human readable text includes terminology such as “extremely useful, “most useful,” and/or other terminology indicating a high degree of relevance of insights 224 to the end user.

Similarly, the human readable text may be assigned to a second band if the human readable text includes terminology such as “average,” “partially useful,” and/or other terminology to indicate a medium degree of relevance of insights 224 to the end user. A medium degree of relevance may be less relevant than a high degree of relevance. Other bands may be associated with a low degree of relevance of insights 224 to the end user, no relevance of insights 224 to the end user, etc.

Therefore, the human readable text obtained as output from fourth LLM 228 may be assigned to a band of the set of bands and a success score corresponding to the assigned band may be identified and used as success score 230 for insights 224. Success scores may be assigned, for example, based on a scale of zero to five with zero being associated with a band indicating no relevance of insights 224 to the end user and five being associated with a band indicating a highest degree of relevance of insights 224 to the end user.

While described herein with respect to assigning success scores using the set of bands and a scale of zero to five, success scores may be assigned using other rule sets and/or other systems of quantifying the degree of relevance of insights 224 to the end user without departing from embodiments disclosed herein.

Success score 230 may be used for insight evaluation process 234. During insight evaluation process 234, success score 230 may be compared to success criteria 232. Insights 224 may be acceptable when success score 230 meets success criteria 232. Success criteria 232 may include a success score threshold and/or any other means of determining whether success score 230 is acceptable. The success score threshold may indicate, for example, that any success score over 4 may be considered acceptable.

Insight evaluation process 234 may include generation of result 236, which may indicate whether success score 230 meets success criteria 232. For example, result 236 may include a data structure indicating that insights 224 are acceptable. Result 236 may also include any amount of information from success score 230 (e.g., the human readable text obtained from fourth LLM 228, the quantitative score of success score 230, and/or other data).

If result 236 indicates that insights 224 are acceptable (e.g., success score 230 meets success criteria 232), a data package may be provided to second LLM 214 to be used as part of a reinforced learning process (not shown). The data package may include question 218, result 236, and/or other information. As insights based on question 218 were considered acceptable in this example, the reinforced learning process may include feeding question 218 (and/or a label indicating that question 218 was successful) to second LLM 214 to increase a likelihood of questions generated by second LLM 214 at future points in time being usable to obtain insights that may meet success criteria 232.

Turning to FIG. 2E, a fifth data flow diagram in accordance with an embodiment is shown. The fifth data flow diagram may illustrate data used in and data processes performed in evaluating relevance of insights to an end user when the insights are not considered acceptable.

If result 236 indicates that insights 224 are not acceptable, question modification process 238 may be performed using at least result 236. Question modification process 238 may include modifying question 218 to obtain updated question 240. Question modification process 238 may include changing how question 218 is phrased and/or changing at least a portion of subject matter of question 218.

For example, question 218 may indicate that all data of contextual data 220 is to be used to establish a causal relationship between a leading indicator and a prediction. However, updated question 240 may indicate that a portion of contextual data 220 is to be used to establish the causal relationship between the leading indicator and the prediction. Modifications to question 218 may be based, at least in part, on portions of insights 224 identified as contributing to success score 230.

Specifically, a first portion of contextual data 220 may have a higher degree of relevance to a data analyst than to an engineer. Therefore, the first portion of contextual data 220 may be excluded as part of modifying question 218 to attempt to generate an updated question that is more relevant to an engineer than question 218.

Therefore, question modification process 238 may include specifying in updated question 240 that the data source of contextual data 220 that was considered less relevant to the end user is not to be used during interpretation of updated question 240 by third LLM 222. Question modification process 238 may include other modifications based on other data without departing from embodiments disclosed herein.

Updated question 240 may then be ingested by third LLM 222 to obtain updated insights 242. Similarly, updated insights 242 may be evaluated by fourth LLM 228 while emulating the persona of the end user. If a second success score (not shown) based on updated insights 242 does not meet success criteria 232, updated question 240 may be iteratively modified using methods similar to those described above with reference to modifying question 218 until insights based on the modified question meet success criteria 232.

By generating responses to questions using the third LLM, levels of confidence in predictions generated by inference models may be more efficiently established and, subsequently, it may be determined whether the predictions are usable as a basis for providing computer-implemented services. In addition, by evaluating relevance of the responses (e.g., the insights) to particular end users, a likelihood of generating useful insights may be increased. Doing so may increase a likelihood of timely provision of the computer-implemented services by the end user, which may increase a quality of the computer-implemented services for consumers of the computer-implemented services.

Any of the processes illustrated using the second set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor based devices (e.g., computer chips).

Any of the data structures illustrated using the first and third set of shapes may be implemented using any type and number of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

As discussed above, the components of FIG. 1 may perform various methods to generate questions usable to interpret inference model outputs. FIG. 3 illustrates a method that may be performed by the components of the system of FIG. 1. In the diagram discussed below and shown in FIG. 3, any of the operations may be repeated, performed in different orders, and/or performed in parallel with or in a partially overlapping in time manner with other operations.

Turning to FIG. 3, a flow diagram illustrating a method of generating responses to questions usable to interpret inference model outputs by end users in accordance with an embodiment is shown. The method may be performed, for example, by a data source, a downstream consumer, an inference model manager, an LLM manager, and/or any other entity without departing from embodiments disclosed herein.

At operation 300, a question may be obtained. The question may be usable to establish a level of confidence in an output and the question may be generated by a second LLM. Obtaining the question may include: (i) obtaining, based at least on an output generated by an inference model, analytic data generated by a first LLM, (ii) obtaining, using at least the analytic data and a set of question generation templates, the question generated by the second LLM.

Obtaining the analytic data may include: (i) feeding first ingest data into the first LLM, (ii) obtaining, as output from the first LLM, the analytic data, and/or (iii) other methods. The first ingest data may include: (i) inference model ingest data used by the inference model to generate the output, (ii) the output, (iii) a set of queries including questions to be answered by the first LLM, and/or (iv) other data.

Feeding the first ingest data into the first LLM may include: (i) obtaining the first ingest data, (ii) providing the first ingest data to the first LLM as input for the first LLM, and/or (iii) other methods.

Obtaining the analytic data as output from the first LLM may include: (i) reading the analytic data from storage, the analytic data being automatically stored following generation by the first LLM, (ii) obtaining the analytic data from another entity responsible for operating the first LLM, and/or (iii) other methods.

Obtaining the question using at least the analytic data and the set of question generation templates may include: (i) reading the question from storage, (ii) receiving the question in the form of a message from another entity (e.g., via a transmission over a communication system), (iii) generating the question, and/or (iv) other methods.

Generating the question may include: (i) feeding the analytic data into the second LLM, (ii) obtaining the question as an output from the second LLM, and/or (iii) other methods.

At operation 302, insights intended to provide a response to the question may be obtained using at least the question and contextual data. Obtaining the insights may include: (i) reading the insights from storage, (ii) receiving the insights from another entity responsible for generating the insights (e.g., by hosting and operating a third LLM), (iii) generating the insights, and/or (iv) other methods.

Generating the insights may include: (i) obtaining the contextual data from a contextual data repository, (ii) feeding at least the question and the contextual data into the third LLM, (iii) obtaining, as output from the third LLM, the insights, and/or (iv) other methods.

At operation 304, a success score for the insights may be obtained based on end user information and the insights. Obtaining the success score may include: (i) ingesting, by the fourth LLM, the end user information to emulate a persona of the end user, (ii) evaluating, by the fourth LLM while emulating the persona, an extent to which the response to the question provided by the insights is relevant to the end user, and/or (iii) other methods.

Ingesting the end user information to emulate the persona may include: (i) obtaining the end user information (e.g., by searching publicly available online sources), (ii) processing the end user information to place the end user information in a format readable by the fourth LLM (e.g., text extraction, data aggregation, data summarization), (iii) feeding the end user information into the fourth LLM to indicate a persona for emulation, (iv) modifying parameters of the third LLM based on the end user information to emulate the persona, (v) providing questions related to information represented in an internal state of the fourth LLM to validate that the information is correctly represented, (vi) validating the emulation of the persona by the fourth LLM by evaluating responses to targeted questions provided to the fourth LLM to interrogate the persona, and/or (iv) other methods.

Evaluating the extent to which the response to the question provided by the insights is relevant to the end user may include: (i) obtaining human readable text as output from the fourth LLM, the human readable text including terminology that reflects the extent to which the response to the question provided by the insights is relevant to the end user, (ii) assigning the success score to the human readable text, and/or (iii) other methods.

Assigning the success score to the human readable text may include comparing the human readable text to a rule set that includes a set of bands, each band of the set of bands being associated with a range of human readable text and a corresponding success score. To assign the human readable text to a band of the set of bands, terminology included in the human readable text may be compared to terminology included in the range of human readable text associated with each band. If a portion of the terminology included in the human readable text matches (e.g., to an extent considered acceptable) a portion of the terminology included in the range of human readable text associated with a band, the human readable text may be assigned to that band and a success score corresponding that band may be assigned to the human readable text.

Success scores may be assigned to the human readable text via other methods (e.g., the human readable text may be provided to another entity responsible for assigning success scores) and/or via comparison to other rule sets (e.g., including a continuous scale for success score assignment rather than a quantized approach using the bands) without departing from embodiments disclosed herein.

At operation 306, it may be determined whether the insights are acceptable based the success score and success criteria. Determining whether the insights are acceptable may include: (i) obtaining the success criteria, (ii) obtaining a quantification of the success score indicated by a threshold of the success criteria, (iii) determining whether the success score exceeds the quantification of the success score indicated by the threshold of the success criteria, and/or (iv) other methods. For example, the insights may be acceptable if the success score exceeds the quantification of the success score indicated by the threshold of the success criteria.

Obtaining the success criteria may include: (i) reading the success criteria from storage, the success criteria, (ii) receiving the success criteria as a transmission over a communication system from another entity responsible for generating the success criteria, (iii) generating the success criteria, and/or (iv) other methods.

If the insights are determined to be acceptable, the method may proceed to operation 308.

At operation 308, the insights may be provided to a downstream consumer for use in interpreting the output. Providing the insights to the downstream consumer may include: (i) storing the insights in storage for subsequent retrieval by the downstream consumer and/or an intermediary entity, (ii) transmitting the insights to the downstream consumer via a communication system, the insights being encapsulated in a data structure, and/or (iii) other methods.

If the insights are determined to be acceptable, reinforced learning may be applied to the second LLM using at least the question to increase a likelihood of questions generated by the second LLM at future points in time being usable to generate insights that meet the success criteria. Applying reinforced learning to the second LLM may include: (i) providing feedback to the second LLM, the feedback indicating that the question generated a favorable result (e.g., the insights based on the question were acceptable), (ii) providing the feedback to another entity responsible for managing the reinforced learning process, and/or (iii) other methods.

The method may end following operation 308.

Returning to operation 306, if the insights are determined to not be acceptable, the method may proceed to operation 310.

At operation 310, updated insights may be obtained. Obtaining the updated insights may include: (i) modifying the question to obtain an updated question, (ii) using the updated question as input for the third LLM to generate the updated insights, and/or (iii) other methods.

Modifying the question may include: (i) editing the question to add or remove portions of text included in the question, (ii) providing instructions to another entity responsible for editing the question, the instructions indicating how the question is to be changed, and/or (iii) other methods.

Editing the question may include: (i) obtaining feedback (e.g., from the success score, as an additional output from the fourth LLM) indicating portions of the insights and a degree of relevance of each portion of the insights, (ii) identifying one or more edits to be made to the text included in the question based on the feedback, and/or (iii) other methods.

Using the updated question as input for the third LLM may include: (i) feeding at least the updated question and contextual data into the third LLM, (ii) obtaining, as a result from the third LLM, the updated insights, and/or (iii) other methods.

Obtaining the updated insights may also include providing instructions to the third LLM, the instructions indicating that a portion of the contextual data is not to be used to generate the updated insights. Providing the instructions to the third LLM may include: (i) obtaining the instructions, (ii) transmitting the instructions (e.g., via a communication system, via an application programming interface, via an in band communication channel) to an agent managing the third LLM, and/or (iii) other methods. The instructions may be based, at least in part, on information included in the success score and/or other analyses of relevance of portions of the insights to the end user.

Following operation 310, the method may proceed to operation 306. At operation 306, it may be determined whether the updated insights are acceptable. Determining whether the updated insights are acceptable may be performed via methods similar to those described with respect to determining whether the insights are acceptable as described in operation 306.

If the updated insights are not acceptable, the method may include continuing to iteratively modify the updated insights until the modified updated insights are acceptable. Continuing to iteratively modify the updated insights may include: (i) modifying the updated insights via methods similar to those described in operation 308, (ii) determining whether the modified updated insights are acceptable via methods similar to those described in operation 304, and/or (iii) other methods.

Any of the components illustrated in FIGS. 1-2E may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high-level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random-access memory (RAM), dynamic RAM (DRAM), synchronous DRAM (SDRAM), static RAM

(SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a Wi-Fi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also, a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs, or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

1. A method of interpreting an output generated by an inference model, the method comprising:
obtaining the output using ingest data for the inference model, the output comprising a prediction and the output being requested by an end user;
obtaining a leading indicator for the ingest data using a first large language model (LLM);
obtaining an emerging trend for the leading indicator using the first LLM;
obtaining a question based on the leading indicator and the emerging trend, the question being adapted to identify facts to establish a causal relationship between the prediction, the leading indicator, and the emerging trend and being generated by a second large LLM;
obtaining, using at least the question and contextual data from a plurality of data sources, insights comprising the causal relationship and being generated by a third LLM;
obtaining, based on end user information and the insights, a success score for the insights, the success score being generated by a fourth LLM and the success score indicating an extent to which the insights are useful to an end user associated with the end user information;
making a first determination, based on the success score and success criteria, regarding whether the insights are acceptable; and
in a first instance of the first determination in which the insights are acceptable:
contextualizing the output to the end user using the insights as a response for the end user.

2. The method of claim 1, further comprising:
in a second instance of the first determination in which the insights are not acceptable:
obtaining updated insights;
making a second determination regarding whether the updated insights are acceptable; and
in a first instance of the second determination in which the updated insights are not acceptable:
continuing to iteratively modify the updated insights until the modified updated insights are acceptable.

3. The method of claim 2, wherein obtaining the updated insights comprises:
modifying the question to obtain an updated question; and
using the updated question as input for the third LLM to generate the updated insights.

4. The method of claim 1, wherein the end user information comprises at least one selected from a list consisting of:
text generated by the end user;
an educational history of the end user;
an employment history of the end user; and
historic behavior of the end user.

5. The method of claim 4, wherein obtaining the success score comprises:
ingesting, by the fourth LLM, the end user information to emulate a persona of the end user, the persona being usable to predict behavior of the end user; and
evaluating, by the fourth LLM while emulating the persona, an extent to which the response to the question provided by the insights is relevant to the end user.

6. The method of claim 5, wherein the end user is an individual.

7. The method of claim 5, wherein the end user is a role within a business and the business having at least two individuals that perform the role.

8. The method of claim 1, wherein the insights are acceptable when the success score meets the success criteria.

9. The method of claim 1, wherein obtaining the question comprises:
obtaining, based on at least the output, analytic data generated by a first large language model (LLM), the analytic data comprising:
leading indicators from ingest data used by the inference model to generate the output; and
emerging trends from the ingest data used by the inference model to identify the leading indicators; and
obtaining, using at least the analytic data and a set of question generation templates, the question generated by a second LLM.

10. The method of claim 9, wherein obtaining the analytic data comprises:
feeding first ingest data into the first LLM, the first ingest data comprising:
inference model ingest data used by the inference model to generate the output; and
a set of queries comprising questions to be answered by the first LLM, the questions being based on the inference model ingest data and the output; and
obtaining, as output from the first LLM, the analytic data.

11. The method of claim 10, wherein the question is usable to identify facts to establish a causal relationship between at least a portion of the output and at least a portion of the analytic data.

12. The method of claim 1, wherein the contextual data comprises economic report data.

13. The method of claim 1, further comprising:
in the first instance of the first determination in which the insights are acceptable:
applying reinforced learning to the second LLM using at least the question to increase a likelihood of questions generated by the second LLM at future points in time being usable to obtain insights that meet the success criteria.

14. The method of claim 1, wherein the output comprises a prediction for a condition impacting a business at a future point in time.

15. The method of claim 14, wherein the condition impacting the business at the future point in time is a change in availability of supply of a product from a supplier.

16. A non-transitory machine-readable medium having instructions stored therein, which when executed by a processor, cause the processor to perform operations for interpreting an output generated by an inference model, the operations comprising:
obtaining the output using ingest data for the inference model, the output comprising a prediction and the output being requested by an end user;
obtaining a leading indicator for the ingest data using a first large language model (LLM);
obtaining an emerging trend for the leading indicator using the first LLM;
obtaining a question based on the leading indicator and the emerging trend, the question being adapted to identify facts to establish a causal relationship between the prediction, the leading indicator, and the emerging trend and being generated by a second large LLM;
obtaining, using at least the question and contextual data from a plurality of data sources, insights comprising the causal relationship and being generated by a third LLM;
obtaining, based on end user information and the insights, a success score for the insights, the success score being generated by a fourth LLM and the success score indicating an extent to which the insights are useful to an end user associated with the end user information;
making a first determination, based on the success score and success criteria, regarding whether the insights are acceptable; and
in a first instance of the first determination in which the insights are acceptable:
contextualizing the output to the end user using the insights as a response for the end user

17. The non-transitory machine-readable medium of claim 16, further comprising:
in a second instance of the first determination in which the insights are not acceptable:
obtaining updated insights;
making a second determination regarding whether the updated insights are acceptable; and
in a first instance of the second determination in which the updated insights are not acceptable:
continuing to iteratively modify the updated insights until the modified updated insights are acceptable.

18. The non-transitory machine-readable medium of claim 17, wherein obtaining the updated insights comprises:
modifying the question to obtain an updated question; and
using the updated question as input for the third LLM to generate the updated insights.

19. A data processing system, comprising:
a processor, and
a memory coupled to the processor to store instructions, which when executed by the processor, cause the processor to perform operations for interpreting an output generated by an inference model, the operations comprising:
obtaining the output using ingest data for the inference model, the output comprising a prediction and the output being requested by an end user;
obtaining a leading indicator for the ingest data using a first large language model (LLM);
obtaining an emerging trend for the leading indicator using the first LLM;
obtaining a question based on the leading indicator and the emerging trend, the question being adapted to identify facts to establish a causal relationship between the prediction, the leading indicator, and the emerging trend and being generated by a second large LLM;
obtaining, using at least the question and contextual data from a plurality of data sources, insights comprising the causal relationship and being generated by a third LLM;
obtaining, based on end user information and the insights, a success score for the insights, the success score being generated by a fourth LLM and the success score indicating an extent to which the insights are useful to an end user associated with the end user information;
making a first determination, based on the success score and success criteria, regarding whether the insights are acceptable; and
in a first instance of the first determination in which the insights are acceptable:
contextualizing the output to the end user using the insights as a response for the end user

20. The data processing system of claim 19, further comprising:
in a second instance of the first determination in which the insights are not acceptable:
obtaining updated insights;
making a second determination regarding whether the updated insights are acceptable; and
in a first instance of the second determination in which the updated insights are not acceptable:
continuing to iteratively modify the updated insights until the modified updated insights are acceptable.
